(19) United States
(12) Patent Application Publication
(10) Pub. No.: US 2019/0074723 A1
(43) Pub. Date: Mar. 7, 2019

(54) WIRELESS NEAR-FIELD SELF-RESONANT IMPULSE RECEIVER

(71) Applicant: Global Energy Transmission, Co., Woodland, WA (US)

(72) Inventor: Sergey PLEKHANOV, Moscow (RU)

(21) Appl. No.: 16/100,082

(22) Filed: Aug. 9, 2018

Related U.S. Application Data
(63) Continuation of application No. 15/342,060, filed on Nov. 2, 2016, now abandoned.
(60) Provisional application No. 62/249,883, filed on Nov. 2, 2015.

(51) Int. Cl. H02J 50/12

(52) U.S. Cl. CPC H02J 50/12

(57) ABSTRACT

A wireless near-field self-resonant impulse receiver includes a receiver body constructed to receive energy from a low-frequency external field by using an appropriately tuned, high frequency antenna that operates in an impulse mode under preselected self-resonant conditions.

### CROSS-REFERENCE TO RELATED APPLICATIONS

This application is a continuation of U.S. patent application Ser. No. 15/342,060, filed Nov. 2, 2016 and entitled “Wireless Near-Field Self-Resonant Impulse Receiver”, which application is based upon and claims the benefit under 35 U.S.C. § 119(e) of U.S. Provisional Patent Application Ser. No. 62/249,883, filed Nov. 2, 2015, both of which are incorporated herein by reference in their entirety for all purposes.

### BRIEF DESCRIPTION OF THE DRAWINGS

FIG. 1 is a schematic diagram showing the process by which the invention operates.

### DETAILED DESCRIPTION

Various features of a receiver for receiving electromagnetic (EM) energy transmitted from a transmitter or other source of EM energy are described below. Independent devices having one or more appropriate antennas may receive the transmitted EM-waves, which then may be used to power the devices, store the energy for use by other devices, or output the energy to yet another device.

The rectenna device or rectifying antenna receives electromagnetic energy in the far-field area of the transmitter of such energy (i.e. far-field wireless energy transmission) and converts it into direct-current electricity. This antenna allows harvesting electromagnetic (EM) energy over a wide frequency band. For example, this is the core idea of the Freevolt™ devices made by Drayson Technologies Limited of London, England. These devices convert ambient radio-frequency EM energy into direct-current electricity for powering low-power devices. Unfortunately, the receiving antenna in a rectenna device may provide energy reception with high efficiency only in the case in which the impedance of the antenna matches the impedance of the external EM-field. Thus, despite the potential of receiving energy over a wide frequency band, a conventional rectenna is not able to use this energy with high efficiency for frequencies which are far away from the resonant frequency of the antenna in the device.

Another well-known approach is the use of the near-field area of the transmitter for wireless energy transmission. In a near-field mode of operation of the system, resonant coupling of receiver and transmitter circuits is usually used in order to achieve high efficiency in energy transmission. The well-known example of such system, as described in U.S. Pat. No. 7,741,734, is used in wireless power transfer systems made by Witricity Corporation. The main advantage of such approach is that it allows using the near field region in which an amplitude of reactive non-radiative near-field signals is several orders of magnitude higher than the radiative far-field signal components, which increase transmission efficiency accordingly. In addition, the lower the frequency is the higher the radius is of the near-field region, which is approximately equal to a design wavelength of the transmitter.

Unfortunately, in the case of long-distance transmission, which requires use of a low frequency signal in order to use near-field resonant coupling, the technical restrictions do not allow the implementation of this concept. This is because in the case of low frequency signals, the corresponding size of a resonant circuit of high quality factor is comparatively large for both transmitter and receiver. A resonant receiver designed for operation at such low frequencies would have an internal impedance that is so high that it almost completely blocks the ability to receive energy from the transmitter.

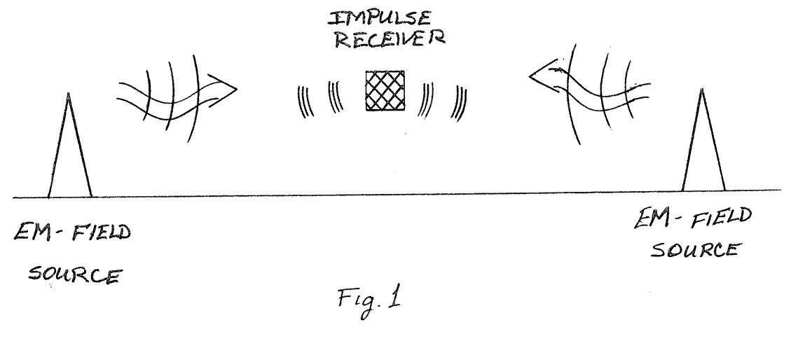

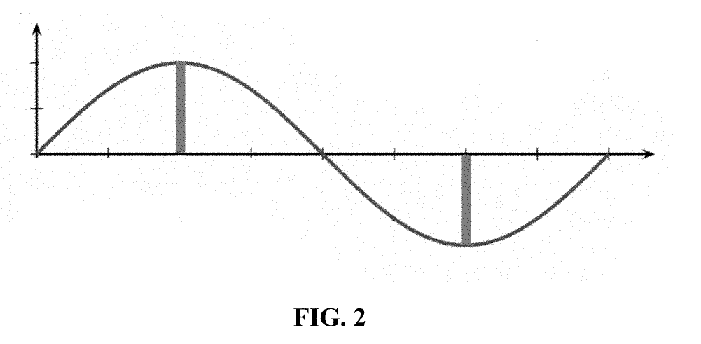

FIG. 1 shows the process by which the wireless near-field self-resonant impulse receiver of the invention operates. The receiver of the invention combines the advantages of both approaches mentioned above (i.e. wide frequency range of the reception of electromagnetic energy as well as use of a near field mode of transmission of an energy) for long-distance wireless energy transmission and reception of very low frequency (from 1 kHz up to 100 kHz) signals with highly efficient reception. An impulse mode of operation of a receiving circuit may be used together with appropriate impedance matching of the receiving antenna.

The same principle may also be applicable for magnetic field antennas.

Some features and components for such a system may include:
a detector of amplitude and direction of propagation of an external field,
a system of breaking or closing of a resonant circuit of the receiver,
a high frequency antenna whose frequency of operation is related to the size of the antenna and is close to a resonant frequency of the antenna itself,
an impulse mode of operating the receiving antenna with a duty cycle depending at least in part on a received external field, and
in some embodiments, feedback from the receiver to the transmitter. Such feedback may be provided over a separate communication channel (such as the Internet, radio transmission, the global system for mobile communication (GSM), WIFI, or other data transfer technology).

The power received from the external field by the normally tuned receiving antenna is

$$= \frac{{U}^{2}}{R} ,$$

where U is a voltage of an external field on the antenna, and R is the total impedance of the antenna, which is a sum of so called radiation resistance, load resistance, and lossy resistance due to losses in receiving circuit:

R=Rᵢ+R_{load}+Rₗₒₛₛ.

We assume that reactive resistance of the antenna is zero due to appropriate tuning of the antenna.

For example in the case of a conventional T-type antenna 30 meters in height, and 40 meters in horizontal length of the upper horizontal part, the capacity of such antenna may be roughly estimated as a capacity of a horizontal cylinder above a perfectly conducting plate:

$$C = \frac{2 πɛ l}{ln ( \frac{h}{r} + \sqrt{{( \frac{h}{r} )}^{2} - 1} )}$$

In the case where ε=1 (air), l=40, h=30, r=0.03 (radius of a wire of an antenna), the estimated capacity of the antenna is equal to 300 pF.

In the case of low frequency of operation equal to 10 kHz, an inductance of

$$L = \frac{1}{{ω}^{2} C} \approx 0.84$$

Henry tunes the antenna to resonant conditions, which provides high efficiency of energy reception by such antenna).

Thus, in the case of such low frequency energy reception, the tuning coil (inductance) of the antenna and thus the active resistance of the tuning coil is large. This means that in the resonance mode of operation the internal impedance of the antenna is typically 10³-10⁴ Ohm for a compact tuning coil of the receiver, and thus a small amount of energy may be received. The radiation resistance of such a short antenna is very low:

$${R}_{i} = 80 {{π}^{2} ( \frac{h}{λ} )}^{2} \approx 7.8 * {10}^{- 4} Ohm$$

An antenna may provide high power when the total active resistance of the antenna (i.e. the sum of the resistance of the load and resistance of the losses) is equal to the radiation resistance of the antenna, i.e.

Rᵢ=R_{load}+Rₗₒₛₛ.

Unfortunately, as it was explained above, the typical resistance of the tuning coil operating at such low frequencies is very high, 10³-10⁴ Ohm (in the case of a compact tuning coil of the receiver) instead of milliohms required for high efficiency power drain by the antenna. This means that in the usual case of energy reception for a frequency of 10 kHz, the receiver with a compact tuning coil will receive a small fraction of energy (typically 10⁻⁸-10⁻⁶) from maximum available power for such antenna. This technical restriction is valid for any frequency below 100 kHz.

The inductance of the tuning coil is proportional to the active resistance of the wire of the coil having a constant radius. For example, a one-layer long solenoid having diameter D, height h, wire radius r with winding step

$$ρ = \frac{Z}{π D}$$

and total length of a wire Z, one calculates the inductance as:

$$\begin{matrix}L = \frac{{μ}_{0} μ {Z}^{2}}{4 π h} \\ = \frac{{μ}_{0} μ {Z}^{2}}{4 π ρ 2 r} \\ = \frac{{μ}_{0} μ {Z}^{2}}{4 π \frac{Z}{π D} 2 r} \\ = \frac{{μ}_{0} μ DZ}{8 r}\end{matrix}$$

At the same time, the resistance of the wire of such coil is

$${R}_{L} = \frac{Z}{π {r}^{2} σ} σ$$

is the conductance of the metal of a wire.

Thus, one gets

$$L = \frac{{μ}_{0} μ DZ}{8 r} = 0.125 {πμ}_{0} μσ rR , or$$

$${R}_{L} = \frac{8 L}{{πμ}_{0} μσ r} = \frac{8}{{πμ}_{0} μσ rC} \frac{1}{{ω}^{2}} ,$$

where C is the constant capacity of the antenna, and ω—is the resonant frequency of the antenna. We conclude that for an increase of resonant frequency ω of the antenna with constant parameters of the tuning coil, the active resistance of the antenna decreases in proportion to ω².

We can neglect the change of resistance of the coil caused by the skin effect on the antenna since it does not change the result. Also, the use of an appropriate wire for the antenna may effectively eliminate the skin effect.

Radiation resistance increases in proportion to ω² according to the following equation:

$${R}_{i} = 80 {{π}^{2} ( \frac{h}{λ} )}^{2} = 80 {{π}^{2} ( \frac{h}{2 π c} )}^{2} {ω}^{2} .$$

There is also resistance due to minor losses and resistance of a load, which are typically almost constant and does not depend on the frequency when the frequency is low.

Thus, the total active resistance is a function of frequency and may be calculated as follows, with the length of tuning coil wire selected to have an inverse relation to the frequency:

$$R ( ω ) = {R}_{i} + {R}_{load} + {R}_{loss} = \frac{α}{{ω}^{2}} + β {ω}^{2} + c 1 ,$$

where

$$α = \frac{8}{{πμ}_{0} μσ rC} and β = 20 {( \frac{h}{c} )}^{2} ,$$

C is the speed of light in a vacuum, C is the self capacity of the antenna, h—is the height of the antenna, r is a radius of the wire of the tuning coil, σ is the conductance of the metal that the coil wire is made of, c1 is the sum of loss resistance and load resistance of the antenna circuit including the antenna itself).

A minimum of the total active resistance occurs when

$$\frac{\partial R ( ω )}{\partial {ω}^{2}} = β - \frac{α}{{ω}^{4}} = 0 , and ω = \sqrt[4]{\frac{α}{β}} .$$

For the situation when h=30 meters, C=300 pF, copper wire of the tuning coil with a radius r=0.7 mm, one gets α≈1.6*10¹¹, β≈2*10⁻¹³, ω≈1.2*10⁶ (0.19 MHz), the active resistance of the tuning coil is approximately 0.1 Ohm, and a radiation resistance is approximately 0.3 ohm.

Thus, due to an increase of resonant frequency of the receiving antenna from 10 kHz to 190 kHz we get a drop of active resistance from typically 10³-10⁴ ohms for a receiver having a compact tuning coil down to a 0.1-1 ohm range, i.e. 4-5 orders of magnitude smaller. This may be caused by decreasing the length of the tuning coil wire and increasing the a radius of the coil wire. That is, the active resistance of the receiver is reduced by 2-3 orders of magnitude by shortening the length of the tuning coil wire, and the rest is caused by increasing the wire diameter.

An objective is to get energy from a low frequency electromagnetic field. From the above it is seen that a useful amount of energy may be effectively received (in terms of practical devices of relatively small size) at much higher frequencies. A solution is that the mode of operation of an antenna in a general case, such as for a resonant LC-circuit, does not require constant harmonic (sinusoidal) oscillation. It may be enough if at each half of the cycle of oscillation (such as for an LC-circuit) the external field coincides with the direction of current flow in the circuit, which thus provides energy to the circuit. The current flow may be switched off when the current in the circuit is zero, for example, after half of the oscillation of the circuit has occurred—i.e. after the current has increased to its maximum and then decreased to zero. The circuit may be closed again as soon as the direction of the external field is in accordance with the polarity of charge on the condenser of the circuit.

Such impulses (or half-oscillations) of the LC-circuit will maintain the resonant mode of operation similar to that of constant harmonic oscillation. Thus, a resonant mode of operation of an antenna (as an LC-circuit) may be maintained in such impulse mode of oscillation.

Thus, an impulse resonant mode of oscillation of a high-frequency antenna is used to receive energy from a low-frequency external field. It may be sufficient to synchronize such high-frequency impulses of the receiving antenna with points of maximum amplitude of the external field as it is shown in FIG. 2, where the vertical axis is amplitude, the horizontal axis is time, the red curve is the amplitude of the external field, and the green impulses at the peaks of the external field represent impulses of current produced in the receiving antenna, which occur at the resonant frequency of the antenna. The resonant frequency of the antenna is much higher than the frequency of the external field, and thus the antenna exhibits a much lower internal resistance to the receiving circuit.

By operating in this impulse mode of oscillation, power received by antenna is higher than that of the full-wave mode of oscillation, and is defined by the equation

$$P = \frac{{U}^{2}}{R ( ω )} = \frac{{U}^{2}}{\frac{α}{{ω}^{2}} + {βω}^{2} + const} .$$

At the same time, the duty cycle is also increased from the low-frequency period of the power wave 1/ω₀ to the period of the much higher resonant frequency of the receiving antenna 1/ω)

Thus, the average power received by such system is roughly determined as follows:

$$P ( ω ) \approx \frac{{U}^{2} {ω}_{0}}{( \frac{α}{{ω}^{2}} + {βω}^{2} + c 1 ) ω} ,$$

where ω₀ is the low-frequency of the external power wave and ω is the resonant frequency of the high frequency receiving antenna, which functions in a mode of impulses at half-cycles of the self-resonant oscillation.

The maximum of average power is related to a point where

$$\frac{\partial P ( ω )}{\partial ω} = \frac{{U}^{2} {ω}_{0} ( - \frac{α}{{ω}^{2}} + 3 {βω}^{2} + c 1 )}{{( \frac{α}{ω} + {βω}^{3} + c 1 * ω )}^{2}} = 0 ,$$

Thus we get the maximum power condition as

$$- \frac{α}{{ω}^{2}} + 3 {βω}^{2} + c 1 = 0.$$

Solving this equation for ω, the condition of maximum power is

$${ω}^{2} = \frac{- c 1 + \sqrt[2]{c {1}^{2} + 4 * 3 βα}}{2 * 3 β} = \frac{c 1 ( \sqrt[2]{1 + \frac{12 αβ}{c {1}^{2}}} - 1 )}{6 β} .$$

For example, taking parameters from the analysis above (a≈1.6*10¹¹, β≈2*10⁻¹³, and active resistance of the antenna itself as c1=0.01 ohm), one gets

$$ω = \sqrt[2]{\frac{c 1 ( \sqrt[2]{1 + \frac{12 αβ}{c {1}^{2}}} - 1 )}{6 β}} \approx 0.7 * {10}^{6} ( 0.11 MHz )$$

And P=U²ω₀*3*10⁻⁶, so in the case where ω₀=6.28*10⁴ (10 kHz) one gets P=0.18 U².

Thus, the power gained by the antenna in such mode of operation is increased by 4 orders of magnitude compared to the typical situation in which the internal resistance of losses in a circuit is equal to several kiloohms. Further, there exists the possibility of using a compact tuning coil, which makes the receiving device more compact, for draining power from a low frequency such as 10 kHz.

Thus, it is possible to receive enemy from a low-frequency external field by using an appropriately tuned high frequency antenna in an impulse mode of operation in self-resonant conditions as described above.

Moreover, due to the absence of a restriction to a constant, strongly harmonic oscillation of the receiving system, it is possible to receive energy with such a system over a wide frequency band, which is below the self-resonant frequency of the receiving antenna, simultaneously. One may use a detector of amplitude and direction of external fields, whether or not they are sinusoidal orcoherent. Energy may be received from peaks of the external field. The external field may include interference from noise fields, man-maid fields, and so on. The system may also receive energy from a narrow frequency band with the high efficiency using the resonant mode of operation of the receiving antenna. This may be so, regardless of how many frequency bands are being used simultaneously. If the system is not producing enough energy from one frequency band, additional frequency bands may be added by using additional transmitters tuned to different frequency bands. This allows the system to respond to an increase in demand power without any special readjustments of the system or its components.

Additionally, by using a low-frequency power wave, the system may operate in the near-field region of the transmitter, which transmitter may also concurrently provide long-distance wireless transmission.

A resonant coupled near-field wireless energy transmission system, such as the Witricity™ system mentioned above, has a significant shortcoming in the absence of feedback from a receiver to the transmitter. Such feedback may automatically occur in the case of resonant coupling. In order to provide feedback, an additional system may be used to send to the transmitter information regarding power level required by the receiver. The transmitter may then respond to provide more power at the same frequency or by adding more frequencies of power transmission. Billing information can also be incorporated in the communication provided in this feedback loop.

A system as described above may have one or more of the following characteristics:
Use of near-field wireless energy transmission over a long distance using a low frequency power wave.
Low radiation losses of a transmitter using a low frequency power wave.
Safe operation due to the low frequency range used.
Receive energy from a very wide range of frequencies that are below the self-resonant frequency of the receiving antenna.
Low amplitude of the field generated by the transmitter in a particular narrow frequency band due to energy being spread in a wide frequency band.
In the case where the amount of energy received by the system from one particular transmitter is not enough, additional transmitters operating at different frequencies and locations may be used effectively to increase the amount of energy received by the same receiver.
Energy may be received from external low-frequency electromagnetic noise, such as the noise that exists in the VLF range provided by light fixtures worldwide, for use in low-powered devices, which energy may be considered “free and forever” energy for such devices, particularly at remote locations.
Multiple receivers in the same spot, i.e., in a close area, may be used to receive energy independently from the same field without adversely affecting the operation of each other by varying the time of impulses at each receiver around the peak amplitude of the low-frequency power wave, regardless of the physical distance between the receivers.
A single receiver may use a plurality of antennas to increase the power level of the received energy.
The sizes of devices receiving the energy may be scaled between large and small, even to the point potentially of integrated circuit size as permitted by the size requirements of the receiving antenna(s), to provide power to a corresponding range of different types of devices or apparatus.

Inventions embodied in various combinations and subcombinations of features, functions, elements, properties, steps and/or methods may be recited in claims of a related application. Such claims, whether they focus on a different invention or the same invention, and whether different, broader, narrower, or equal in scope to the original claims, are also regarded as included within the subject matter of the present disclosure.

What is claimed is:

1. A wireless near-field self-resonant impulse receiver, comprising:
a receiver body constructed to receive energy from a low-frequency external field by using an appropriately tuned high frequency antenna that operates in an impulse mode under preselected self-resonant conditions.
